(19) United States
(12) Patent Application Publication
(10) Pub. No.: US 2003/0015219 A1
(43) Pub. Date: Jan. 23, 2003

(54) Cleaning process and composition

(76) Inventors: Joseph I. Kravitz, Champlin, MN (US); Richard O. Ruhr, Buffalo, MN (US); Andrew T. Gioino, St. Paul, MN (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 09/839,342

(22) Filed: Apr. 20, 2001

(51) Int. Cl. C23G 1/00; C23G 1/02; C03C 23/00; B08B 9/00; B08B 9/027; B08B 3/00; B08B 3/14; B08B 7/00

(52) U.S. Cl. 134/2; 134/3; 134/22.1; 134/22.11; 134/22.14; 134/22.19; 134/26; 134/28; 134/36; 134/41; 134/42

(57) ABSTRACT

A method for removing gross soils from a substrate during a multi-step cleaning process comprising the step of flushing the substrate with a pre-rinse solution prior to application of a cleaning solution and/or second rinse solution. The pre-rinse solution comprises water and a partially neutralized anionic polymer.

### FIELD OF THE INVENTION

The present invention relates to an improved method of cleaning hard surfaces wherein a pre-rinse solution comprising water and an anionic polymer is used prior to application of a main wash solution. The pre-rinse solution is particularly useful in removing gross soils including minerals and proteins in both solid and semi-solid form prior to application of the main wash solution. Using the method of the present invention, hard surfaces can be cleaned faster using less water and less chemicals at the later stages of the process than previous methods.

### BACKGROUND OF THE INVENTION

Clean-in-place (CIP) systems are very common for use in dairies, breweries and all potable liquid installations, and have in general replaced the older hand cleaning methods. CIP typically involves the circulation of non-foaming or low foaming detergents through process equipment in the assembled state.

A typical basic CIP sequence may consist of five stages (for reference see “Hygiene for Management” by Richard A. Sprenger, 5th Ed., p. 135, published by Highfield Publications) including (1) pre-rinsing with cold water to remove gross soils, (2) circulation of a detergent composition to remove residual adherent debris and scale, (3) intermediate rinse with cold water to remove all traces of detergent, (4) optionally circulating a disinfectant to destroy remaining microorganisms, and (5) a final rinse with cold water to remove all traces of disinfectants. Steps 4 and 5 are not utilized in every system, and many systems currently use a second rinse step following the first pre-rinse prior to circulation of the disinfectant.

There remains a desire, however, for a more gentle cleaning system which reduces the damage to equipment from the use of harsh chemicals, allows a reduction in water consumption, requires lower temperatures, reduces the amount residue from surfactants or sequestering agents and caustic or acidic media thereby resulting in less risk that such residue will end up in food or beverages, less risk of harm to personnel handling the cleaning media, and so forth.

Furthermore, there is a desire to reduce the amount of chemicals used in clean-in-place systems because the chemicals can be very difficult to flush completely from the system.

U.S. Pat. No. 6,071,356 describes a method of cleaning-in-place soiled process equipment comprising circulating a solution comprising a protease and a lipase for a sufficient period of time to permit action of the enzymes. U.S. Pat. No. 6,071,356 states that by enzymatic cleaning the amount of chemicals may be reduced, the amount of rinsing water may be reduced, and the chance for residual amounts of surfactants is reduced.

U.S. Pat. No. 6,071,356 suggests the following as typical CIP-sequences that may consist of the following steps:

I: Rinse with water—Enzymatic treatment—Rinse with water.

II: Rinse with water—Enzymatic treatment—Rinse with water—Acid treatment—Rinse with water.

III: Rinse with water—Acid treatment—Rinse with water—Enzymatic treatment—Rinse with water.

IV: Enzymatic treatment—Acid treatment—optionally rinse with water.

V: Ac id treatment—Enzymatic treatment—optionally rinse with water.

VI: Enzymatic treatment—Rinse with water—Acid treatment—optionally rinse with water.

VII: Acid treatment—Rinse with water—Enzymatic treatment—optionally rinse with water.

### SUMMARY OF THE INVENTION

The present invention relates to a method for removing gross soils from a substrate during a multi-step cleaning process comprising the step of flushing the substrate with a pre-rinse solution prior to application of a main wash cleaning solution and/or rinse. The pre-rinse solution comprises water and a partially neutralized anionic polymer.

The partially neutralized anionic polymer may be a polyacrylate, polymethacrylate, polysulfonate, polyphosphate, polyphosphonate, phosphino polycarboxylate, polyaspartate, polycarboxylated alcohol alkoxylate, copolymer or terpolymer thereof, or some mixture thereof.

The present invention further relates to a multi-step method for cleaning hard surfaces comprising the steps of flushing with a pre-rinse solution comprising water and a partially neutralized anionic polymer, and further comprising at least one other step which is either flushing with at least one other rinse solution which is acidic, caustic or neutral and/or cleaning with a main wash solution.

The partially neutralized anionic polymer may be a polyacrylate, polymethacrylate, polysulfonate, polyphosphate, polyphosphonate, phosphino polycarboxylate, polyaspartate, polycarboxylated alcohol alkoxylate, copolymer or terpolymer thereof, or some mixture thereof.

The pre-rinse composition is very effective for removing gross soils and the method of the present invention requires the use of less water and less washing chemicals than conventional compositions and methods.

All U.S. patents and applications and all other documents mentioned anywhere in this application are incorporated herein by reference in their entirety.

### DETAILED DESCRIPTIONS OF THE PREFERRED EMBODIMENTS

The method of the present invention may be applied to any clean-in-place system used for processing, or other equipment known in industry, as well as for other cleaning systems for laundry, dishes, hard surfaces, and so forth.

In particular, the method of the present invention may be used for the removal of gross soils from equipment or other surfaces which come into contact with food such as processing equipment. Gross soils include, but are not limited to, proteins, minerals, fats or carbohydrates including those materials such as milk and milk products including cheese, cream and butter and milk based products, whey, meat and meat products, animal feeds, as well as any other foodstuffs.

The present invention relates to a method of cleaning involving at least two steps, at least one of which involves application of an improved pre-rinse composition that is particularly effective for removal of gross soils such as those described above and including minerals and proteins in both solid and semi-solid form. The soil particles removed by the pre-rinse composition include those having a charge. The pre-rinse composition is applied during the first step of the cleaning process which is then followed by a main wash and/or rinse step. Any main wash composition or other rinse composition may be utilized with the pre-rinse composition of the present invention.

The pre-rinse of the present invention provides an excellent means of removing such particles up front, in the initial stage of the cleaning cycle. This allows a faster cleaning process with the use of less chemicals at the back end, or during the main wash, of the cleaning process. The use of less chemicals results in a method of cleaning that is less damaging to equipment and less hazardous to personnel handling such cleaning compositions. The cleaning process also allows for more economic efficiency because it is faster and involves less chemical usage.

A rinsing step may be distinguished from a washing step in the following way.

A “rinsing” step may typically be referred to as a “flushing” step. This is typically a short step in which water, or in this case, a chemical solution, is passed through or over the equipment or substrate to be cleaned, and goes directly to drain or is recirculated, but preferably goes to drain. The primary purpose of a rinse step is to remove loosened or non-adherent soil.

A “washing” step may typically be referred to as a cleaning step, in contrast to a rinsing step, above, which may be defined as a multi-pass step in which a chemical solution which is acidic, caustic or neutral, and which may optionally contain surfactants, water hardness conditioners, and enzymes, is circulated through the equipment to remove the adherent tenacious soils from equipment or substrates including metallic, polymeric or textile type surfaces.

In one specific embodiment of the present invention there is also a second rinsing step in which a caustic or acidic rinse solution is used.

The pre-rinse solution of the present invention is a water based solution comprising an anionic polymeric component useful in the removal of gross soils or proteinaceous soils and minerals.

The anionic polymers useful herein are anionic, partially neutralized, water dispersible or water soluble polymers, at least when in the form of alkali metal, ammonium or substituted ammonium salts.

The degree of neutralization of the anionic polymer of the present invention is determined by the pH because this determines the charge density, or in other words, determines the number of negative charges per molecule. The pH is typically from about 2 to about 13, preferably about 4 to about 11, and even more preferably about 5 to about 10.

Examples of useful classes of partially neutralized anionic polymers include, but are not limited to, polyacrylates, polymethacrylates, polyphosphonates, polyphosphates, polycarbonates, polysulfonates, phosphino polycarboxylates, polyaspartates, polycarboxylated alcohol alkoxylates, polyhydroxysulfonates, polyacetates, hydrolyzed polyacrylamide, hydrolyzed polymethacrylamide, hydrolyzed polyacrylonitrile, hydrolyzed polymethacrylonitrile, and so forth. Copolymers and terpolymers of these polymers are also useful herein, as well as mixtures of the anionic polymers. Hereinafter, the term copolymer will be used to encompass terpolymers and so forth.

Some of the anionic polymers useful herein are those comprised of at least one monomer which is an monoethylenically unsaturated monocarboxylic acid having from 3 to 8 carbon atoms and monoethylenically unsaturated carboxylic acids having from 4 to 8 carbon atoms including, but not limited to, acrylic acid, methacrylic acid, vinylacetic acid, allylacetic acid, propylideneacetic acid, ethylenepropionic acid, dimethylacrylic acid, ethylacrylic acid, crotonic acid, maleic acid, fumaric acid, itaconic acid, methaconic acid, methylenemalonic acid, citraconic acid, and also salts or, if existent, anhydrides thereof. These monomers are polymerized either to homopolymers or to copolymers. Such polymers are discussed in U.S. Pat. No. 5,126,069 which is incorporated by reference herein in its entirety.

Some examples of specific copolymers and terpolymers that find utility herein include, but are not limited to, acrylamide/sodium acrylate copolymers, acrylamide/sodium(meth)acrylate copolymers, acrylamide/acrylamido-propylsulfonic acid/sodium acrylate, acrylamide/acrylamide-propylsulfonic acid, and so forth.

Other examples of useful anionic polymers are found in U.S. Pat. No. 5,597,789, U.S. Pat. No. 5,084,535, and U.S. Pat. No. 4,530,766 all of which are incorporated by reference herein in their entirety.

Preferred classes of polymers for use herein are the polyacrylates and polymethacrylates and copolymers and terpolymers thereof such as the acrylate-methacrylate copolymers. The weight average molecular weight of these polymers is from about 500 to about 15,000 and is preferably within the range of from 750 to 10,000. These polymers are commercially available, and methods for their preparation are well-known in the art.

Commercially available polymers include COLLOID® 207 polyacrylic acid solution available from Colloids, Inc. in Newark, N.J.; AQUATREAT® AR-602-A polyacrylic acid solution available from Alco Chemical Corp. in Chattanooga, Tenn.; the GOODRITE® K-700 series of polyacrylic acid solutions (50-65% solids) and sodium polyacrylate powders and solutions (45% solids) available from B. F. Goodrich Co.; and the sodium or partial sodium salts of polyacrylic acid solutions available under the tradename of ACUSOL® from Rohm and Haas.

A specific example of a partially neutralized anionic polymer useful herein is a polyacrylate having about 10% to about 90% by weight of a substituted acrylic monomer or salt thereof. The polyacrylate has the following general structure:

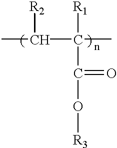

where R₁ or R₂ are independently hydrogen or a C₁ to C₄ alkyl or hydroxyalkyl, and R₃ is hydrogen or an alkali metal salt.

The counterions may be any alkali metal including sodium, potassium and lithium, and ammonium and substituted ammonium. Preferred counterions include the alkali metals, particularly sodium.

Any combination or admixture of such anionic polymers may be advantageously used in the present invention.

The polymer is useful from about 5 to about 5000 ppm, preferably about 15 to 4000 ppm and more preferably about 25 to about 2500 ppm based on active polymer solution.

Organic or inorganic builders may be utilized in combination with the anionic polymers of the present invention. A builder is typically a material that enhances or maintains the cleaning efficiency of a detergent composition. These builders may be typically grouped into six different categories and include alkalis, phosphates, silicates, neutral soluble salts, acids, and insoluble inorganic builders. Such builders may be selected based on their performance capabilities as different types of builders may perform certain functions better than others. Builders have a number of functions, including inactivation of water hardness accomplished by sequestration or by ion exchange, supplying of alkalinity to a detergent formulation, especially for cleaning acid soils, providing of a buffering effect to maintain alkalinity at an effective level to aid in keeping removed soil from redepositing during washing into emulsified oil and greasy soils, as well as enhancing the cleaning efficiency. Detergent builders are well understood materials, commonly available for use in these aqueous warewashing detergents.

Examples of builders include, but are not limited to, ethylenediaminetetracetic acid (EDTA); nitrilotriacetic acid (NTA); succinic acids such as tartrate monosuccinic acid and tartrate disuccinic acid, oxydisuccinic acid, carboxymethoxysuccinic acid, and so forth; mellitic acid; alkali metal and ammonium borates; hydroxy sulfonates; aluminosilicates; alkali metal carbonates, bicarbonates and sesquicarbonates; alkali metal hydroxides and halides including sodium hydroxide and sodium chloride; sulfates such as sodium sulfate; monomeric phosphate compounds such as sodium orthophosphate and the higher condensed phosphates including tetraalkali metal pyrophosphates; and so forth. Such builders are known to those of skill in the art.

Some specific preferred builders include, but are not limited to, EDTA, diethylenetraminepentaacetic acid, hydroxyethylethylenediaminetetraacetic acid, aminotri(methylenephosphonic acid), 2-phosphonobutane-1,2,4-tricarboxylic acid, diethylenetriaminepenta(methylenephosphonic acid), and so forth.

Chelators, particularly those known as sequestrants, which form soluble complexes with metal ions may also be optionally utilized in the pre-rinse solutions in small amounts. In general, a chelating agent is a molecule capable of coordinating (i.e., binding) the metal ions commonly found in natural water to prevent the metal ions from interfering with the action of the other detersive ingredients of a cleaning composition. Some builders also function as sequestering agents. Examples of useful sequestrants include EDTA, NTA, sodium tripolyphosphate, aminocarboxylic acids, condensed phosphates, phosphonates, and so forth. These are only a few examples of the many useful chelating agents available to one of ordinary skill in the art. For a further discussion of chelating agents/sequestrants, see Kirk-Othmer, Encyclopedia of Chemical Technology, Third Edition, volume 5, pages 339-366 and volume 23, pages 319-320, the disclosure of which is incorporated by reference herein. These chelating agents are useful in the pre-rinse from 0 to about 5 wt-% based on active concentration.

Surfactants may also be utilized in the pre-rinse solutions of the present invention. Surfactants may be nonionic, cationic, anionic, or amphoteric or zwitterionic.

Examples of nonionic surfactants, include, but are not limited to, alcohol alkoxylates such as alcohol ethoxylate propoxylates, alcohol propoxylates, alcohol propoxylate ethoxylate propoxylates, alcohol ethoxylate butoxylates, and the like; alkyl-capped alcohol alkoxylates; alkyl phenol ethoxylates such as nonylphenol ethoxylate; ethoxylated and glycol esters of fatty acids including fatty acid ethoxylates, fatty acid ethoxylate propoxylates, fatty alcohol ethoxylates, fatty alcohol ethoxylate propoxylates, and the like; fatty esters of polyalcohol ethoxylates; end-blocked ethoxylates; polyoxyethylene glycol ethers of fatty alcohols such as Ceteareth-27 or Pareth 25-7, and the like; polyoxyethylene substituted acetylene glycol; sorbitan; glucose and sucrose derivatives; glycerol derivatives such as carboxylic acid esters such as glycerol esters and polyoxyethylene esters; carboxylic amides such as diethanolamine condensates, monoalkanolamine condensates, polyoxyethylene fatty acid amides, and the like; polypropylene and polyethylene glycols; polyoxyethylene esters; and polyalkylene oxide block copolymers including an ethylene oxide/propylene oxide block copolymer such as those commercially available under the trademark PLURONIC® available from BASF Wyandotte in Wyandotte, Mich. and the like; TETRONIC® surfactants also available from BASF; and so forth.

Examples of anionic surfactants useful in the present include, but are not limited to, carboxylates such as alkylcarboxylates and polyalkoxycarboxylates, alcohol ethoxylate carboxylates, nonylphenol ethoxylate carboxylates, and the like; sulfonates such as sulfonate esters, alkylsulfonates, alkylbenzenesulfonates, alkylarylsulfonates, alkylbenzene sulfonates, dialkylbenzene sulfonates including xylene sulfonate, alkylnaphthene sulfonates, alkyl diphenyl oxide disulfonates, petroleum sulfonates, sulfonated fatty acid esters, α-olefinsulfonates, and the like; sulfates such as fatty alcohol sulfates or sulfated alcohols, sulfated alcohol ethoxylates, sulfated alkylphenols, alkylsulfates, sulfosuccinates, alkylether sulfates, and the like; phosphate esters such as alkylphosphate esters, and the like; and so forth.

Examples of useful cationic surfactants include, but are not limited to, amines such as primary, secondary and tertiary monoamines with C₁₈ alkyl or alkenyl chains; ethoxylated alkylamines; alkoxylates of ethylenediamine; imidazoles such as a 2-alkyl- 1-(2-hydroxyethyl)-2-imidazolines or 1-(2-hydroxyethyl)-2-imidazolines, and the like; quaternary ammonium salts, such as quaternary ammonium chloride surfactants including n-alkyl(C₁₂ -C₁₈)dimethylbenzyl ammonium chloride, n-tetradecyldimethylbenzylammonium chloride monohydrate, naphthalene-substituted quaternary ammonium chloride such as dimethyl-1-naphthylmethylammonium chloride, and the like; and so forth.

Examples of useful zwitterionic or amphoteric surfactants include, but are not limited to, alkylimidazoline; imidazoline carboxylates; N-alkylbetaines; sultaines; alkylamidobetaines; N-alkylamine oxides; N-alkylamidoamine oxides; protein derivatives; β-N-alkylaminopropionic acids, N-Alkyl-β-iminodipropionic acids; and so forth.

Of course, any combination or admixture of such surfactants will also find utility in the present invention. For a discussion of surfactants, see Kirk-Othmer, Encyclopedia of Chemical Technology, Third Edition, volume 8, pages 900-912. These surfactants are known to one of ordinary skill in the art. The lists above are intended for illustrative purposes only, and not as a comprehensive list of possible surfactants useful herein. The surfactant is useful from 0 to about 5 wt-% based on active concentration.

A second pre-rinse solution may be utilized in the method of the present invention. The second pre-rinse solution may be acidic, caustic or neutral. This step may be typically referred to as a “flushing step” which is involves a short step in which water or a chemical solution is passed through or over the equipment or substrate to be cleaned, and goes directly to drain. The primary purpose of a rinse step is to remove loosened or non-adherent soil.

The pre-rinse solution of the present invention may be utilized in any cleaning system that involves the use of a pre-rinse prior to a main wash and/or second rinse step. The pre-rinse composition of the present invention may be used in combination with any type of main wash solution and/or other rinse solution. In contrast to a rinse, which may be as simple as flushing with water, and which is typically flushed through the system and out through a drain, a main wash solution is typically circulated through the system.

However, main wash solutions may be categorized into broad ranges including the enzymatic compositions, caustic compositions, acidic compositions, and neutral compositions.

The main wash solution composition may include acid or basic components, anionic or nonionic surfactants, chelating agents, water hardness modifiers, organic or inorganic builders, fragrances, surfactants, dyes, solvents and other conventional ingredients.

An alkaline main wash solution may include about 0.1 wt-% to about 10 wt-% potassium or sodium hydroxide, 0 to about 10 wt-% of a chelator(s) such as ethylenediaminetetraacetic acid (EDTA) or polyacrylates, 0 to about 5 wt-% of a surfactant(s), 0 to about 5 wt-% of a bleach, and 0 to 1 wt-% of an enzyme based on active solution.

An acidic main wash solution may include 0.1 wt-% to about 10 wt-% of an inorganic acid or a combination of an organic and inorganic acid, 0 to about 5 wt-% of a surfactant(s), and 0 to about 10 wt-% of a chelator(s) such as a phosphonate based on active solution.

A neutral main wash solution meaning it has a pH in the range of about 4 to 9 may include 0 to about 10 wt-% of organic acids, inorganic acids, alkaline salts, acidic salts, or mixture thereof, 0 to about 10 wt-% of a chelator(s), 0 to about 5 wt-% of a surfactant, and 0 to about 1 wt-% of an enzyme based on active solution.

Industries in which the method of the present invention finds utility include dairies, slaughter houses, breweries, feed processing, any type of food processing including fish processing and dairy processing plants, institutional industries such as hospitals and retirement homes, and so forth.

For processing equipment, the surfaces or substrates to be cleaned may include filling machines, sterilizing plates, heat exchangers, bulk tanks, automatic milking machines, pipelines, centrifuges, evaporators, filtration systems and filters, extruders, cooking kettles, coolers, sieves, hydrocyclones, and so forth.

Other hard surfaces include silos, and tanks found in transportation vehicles such as semi trailers and rail cars.

In institutional settings the surfaces or substrates might include cookware such as dishes and utensils, textiles such as hospital gowns, sheets and curtains, hard surfaces such as floors, walls, beds, and countertops, and so forth.

The substrates may be comprised of metals, polymers, textiles, filter materials including membrane filters, and so forth.

The present invention may be utilized in any multi-step cleaning process that involves at least a pre-rinse and a main wash. Such multi-step cleaning processes may be used in laundry washing systems, dishwashing, warewashing, hard surface cleaning, heat transfer surface cleaning, clean-in-place systems, and so forth.

The present invention finds particular utility in clean-in-place washing systems such as those used in milking operations for the removal of proteinaceous soils from dairy equipment including the pipelines. One type of clean-in-place (CIP) washing system for use in a dairy operation is discussed in U.S. Pat. No. 5,896,828 incorporated by reference herein in its entirety. Another type of CIP washing system for use in a liquid foodstuff packaging line is discussed in U.S. Pat. No. 5,845,683 also incorporated by reference herein in its entirety. Food packaging lines of the type described therein are also referred to as form, fill and seal packaging lines.

Other CIP systems in which the pre-rinse composition and method of the present invention might be used are described in U.S. Pat. No. 4,964,444, U.S. Pat. No. 4,688,611, U.S. Pat. No. 4,593,730, U.S. Pat. No. 4,527,377, U.S. Pat. No. 4,396,044, U.S. Pat. No. 4,218,265, U.S. Pat. No. 3,513,024, and U.S. Pat. No. 3,430,639 all of which are incorporated by reference herein in their entirety.

The pre-rinse solutions of the present invention may also be utilized in dishwashing systems.

The embodiments described above are intended to be illustrative of the present invention and are not intended to limit the scope of the invention in any way. The following non-limiting examples further illustrate the present invention.

### EXAMPLES

### Example 1

An additive containing a partially neutralized anionic polymer was added at a concentration of 1000 ppm to water. The pH of the solution was 5-6. The additive had the following composition.

| | |
|---|---|
| 50.6 wt % | deionized water |
| 0.2 wt % | tetrasodium EDTA liquid (40% active) |
| 13.2 wt % | potassium hydroxide |
| 19.5 wt % | 5-10% neutralized polyacrylic acid (50% active) |
| 16.5 wt % | potassium carbonate |

The cleaning process initially consisted of a water pre-rinse, an acid flush to drain, an acid wash, and a water post-rinse used for cleaning a permeate evaporator (deproteinized) to remove whey and whey components. The solids remaining in the evaporator were measured on two consecutive days, day 2 with the additive and day 1 without the additive.

The amount of solids, on a % weight basis, was measured after the finisher during pre-rinse with water and no additive, and with a solution of water with the pre-rinse additive of the present invention. The finisher is the final stage of the whey evaporator. The effluent flowing out of the finisher is the total soil load as it is removed during the pre-rinse. This is in contrast with the hicon which is the high concentration stage prior to the finisher.

The following data illustrates the increase in the amount of solids removed when the additive of the present invention is used in the pre-rinse as compared to no additive. During that same cleaning cycle, the solids content was also measured in the hicon. This data is found in table 2.

TABLE 1
% Solids Effluent After Finisher During Pre-Rinse

| Time (minutes) | % Solids without additive | % Solids with additive |
|---|---|---|
| 0 | 23.5 | 39.2 |
| 1 | 22.0 | — |
| 2 | 20.5 | 33.0 |
| 3 | 20.0 | 30.5 |
| 4 | 19.1 | 28.7 |
| 5 | 18.0 | 26.0 |
| 6 | — | — |
| 7 | — | 22.9 |
| 8 | — | — |
| 9 | 16.0 | 21.6 |
| 10 | — | 19.6 |
| 11 | — | — |
| 12 | 15.7 | 17.6 |
| 13 | 16.0 | 17.2 |
| 14 | 16.0 | 17.0 |

The above data indicates that more solids are removed during the pre-flush stage when the additive is present.

The solids content was then measured for the hicon which is the last evaporation chamber in the system prior to the finishing chamber. This is a high concentration stage. The following data represents on a % solids basis, how much was left in the finishing stages after using a water pre-rinse with no additive and a solution of water and an additive according to the invention.

TABLE 2
Solids after HICON and
finishing stages during the acid flush following the pre-rinse

| | |
|---|---|
| | % Solids |
| % Solids | After HICON |

| Time | After Finisher | | No | |
|---|---|---|---|---|
| (minutes) | No Additive | Additive | Additive | Additive |
| 0 | 32.3 | 27.7 | 17.4 | 18.2 |
| 1 | — | 28.1 | — | 11.3 |
| 2 | 31.5 | 26.7 | 14.2 | 6.3 |
| 3 | — | 25.8 | — | 4.2 |
| 4 | 30.0 | 24.9 | 12.2 | 3.5 |
| 5 | — | 24.4 | — | 2.5 |
| 6 | 29.5 | — | 11.6 | — |
| 7 | 28.9 | 23.7 | 10.4 | 1.8 |
| 8 | — | 23.0 | — | 0.1 |
| 9 | 28.8 | 22.0 | 9.2 | 0.1 |
| 10 | 28.2 | 21.1 | 6.3 | 0.1 |
| 11 | 27.3 | 21.2 | 3.0 | 0.1 |
| 12 | 27.0 | — | 1.1 | — |
| 13 | 25.9 | 21.5 | 0.1 | 0.1 |

The above data, Table 2, indicates that the % solids in the hicon and after the finishing stage falls off more rapidly during the acid flush to drain when the additive is present in th pre-rinse. This indicates that there is less soil present after the pre-rinse stage when the additive is used and consequently less soil left to be removed by the chemical flush.

### Examples 2-3

In examples 2-3, panels are prepared for soil removal testing. In preparation of the panels, 4.0 (+/−0.04) grams of condensed whole whey from an evaporator concentrating cheddar whey to 50% solids was painted on to clean two inch by five inch 304 stainless steel panels using a brush. Panels were placed in a pressure cooker containing a pool of water and the pressure cooker was placed on a hot plate set at 215° F. for 4 hr and 15 min. The steaming action was used to simulate the interior of an evaporator. The upper, outer surface of the pressure cooker read 138° F. throughout soil panel preparation time.

The panels were then subjected to immersion testing at 140° F. Use dilution solutions were prepared as described in the accompanying examples below in tables 3-4 by dissolving ingredients in water and then bringing the solution to a temperature of 140° F. Each panel was immersed in the appropriate use solution and observations on the soil removal were made at specific time intervals. The panels were rinsed with distilled water after the immersion testing and then stained for residual protein using Coomassie Blue R dye which is known in the art for increasing the visibility of protein stains.

Two sets of tests were run, the results of which are found in tables 3-4. In table 3, Solution A is used as a control standard, Solution B represents a composition of the present invention and Solution C represents a composition of the industry's standard cleaning solution.

TABLE 3

| | Soln A | Soln B | Soln C |
|---|---|---|---|
| Water (6.7 grains | 100 | 99.802 | 96.878 |
| hardness) | | | |
| Tetrasodium EDTA | | 0.0005 | |
| (40% soln) | | | |
| KOH 45% soln | | 0.037 | 0.0775 |
| polyacrylic acid 47% | | 0.0575 | |
| soln (5-10% neutralized) | | | |
| potassium carbonate | | 0.103 | |
| NaOH | | | 2.5 |
| Low foam amine oxide | | | 0.0211 |
| surfactant | | | |
| sodium | | | 0.25 |
| ethylenediaminetetraace- | | | |
| tate | | | |
| Potassium gluconate | | | 0.25 |
| (gluconic acid) | | | |
| Aminotri(methylene- | | | 0.023 |
| phosphonic acid) | | | |
| immersion temperature | 60° C. | 60° C. | 60° C. |

In Weight %
Observation Results at Varying Times

| | |
|---|---|
| 1 minute: | |
| Soln A | some swollen soil falls off. 90% of heavy soil remains. |
| Soln B | 90% heavy soil and 10% light soil remains. |
| Soln C | not observed |
| 2 minutes: | |
| Soln A | not observed. |
| Soln B | not observed. |
| Soln C | 100% heavy soil remains, soil swollen. |
| 5 minutes: | |
| Soln A | 80% heavy soil and 20% light soil remains |
| Soln B | 25% heavy soil and 75% medium soil remains. |
| Soln C | 100% heavy soil remains, soil swollen. |
| 15 minutes: | |
| Soln A | 25% heavy soil and 75% medium soil remains |
| Soln B | 10% heavy soil and 90% medium soil remains. |
| Soln C | 100% soil remains with some thinning, soil swollen. |

The panels were then rinsed for 20 seconds with distilled water:

| | |
|---|---|
| Soln A | 70% medium to light soil and 30% very light soil remains |
| Soln B | 90% bare metal and 10% very slight grain particles |
| | remains. |
| Soin C | 95% bare metal and 5% heavy soil remains. |

The panels were then stained for protein presence with Coomassie
blue R dye are as follows:

| | |
|---|---|
| Soln A | 70% heavy blue stain |
| Soln B | 98% unstained metal and 2% very light blue stain. |
| Soln C | 95% unstained metal and 5% light blue stain. |

From the above result it can be seen that the method of the present invention shows a significant improvement in soil removal cleaning over the industry standard for pre-rinsing with water alone, and shows a slight improvement over a highly alkaline chemical step which is similar to the wash solutions typically used.

Table 4 shows further testing results using the same method as described above. In this example samples 1-3 are used to test varying formulations of the present invention. These are compared to a water control and an alkalinity control. This data shows the effect of alkalinity alone in samples 1 and 2 for comparative purposes. Staining was not used in this experiment.

TABLE 4

| | Water | | | | Alkalinity |
|---|---|---|---|---|---|
| | Control | Sample 1 | Sample 2 | Sample 3 | control |
| Water | 100 | 99.969 | 99.98124 | 99.97728 | 99.99172 |
| Tetrasodium | | 0.00013 | 0.00013 | 0.00013 | |
| EDTA | | | | | |
| (40% soln) | | | | | |
| KOH 45% soln | | 0.00828 | 0.00828 | | 0.00828 |
| polyacrylic | | 0.01224 | | 0.01224 | |
| acid 47% | | | | | |
| soln (5-10% | | | | | |
| neutralized) | | | | | |
| potassium | | 0.01035 | 0.01035 | 0.01035 | |
| carbonate | | | | | |
| immersion | 60° C. | 60° C. | 60° C. | 60° C. | 60° C. |
| temperature | | | | | |

In Weight %
Results of Observations at Varying Times

| | |
|---|---|
| 1 minute: | |
| Water Control | soil starting to break up |
| Sample 1 | soil eroding and falling off |
| Sample 2 | soil eroding off |
| Sample 3 | soil eroding off |
| Alk Control | soil eroding and falling off |
| 5 minutes: | |
| Water Control | soil starting to erode |
| Sample 1 | 20% of metal surface covered with thick film. 80% of |
| | metal surface covered with thin film. |
| Sample 2 | about 50% of the soil thickness has eroded away |
| Sample 3 | about 95% of the soil thickness has eroded away. |
| | 100% of metal surface covered with a thick film. |
| Alk Control | 20% of metal surface is bare. 40% of metal surface is |
| | covered with a thin film. 20% of metal surface is covered |
| | with a thick film. |
| 10 minutes: | |
| Water Control | 40% of metal surface is covered with light film. 60% of |
| | metal surface is covered with a thick film |
| Sample 1 | 50% of metal surface is bare. 50% of metal surface is |
| | covered with a very thin film |
| Sample 2 | 10% of metal surface is bare. 40% of metal surface is |
| | covered with a thin film. 50% of metal surface is covered |
| | with heavy soil. |
| Sample 3 | About 95% of the soil thickness has eroded away. |
| | 100% of metal surface covered with a thin film. |
| Alk Control | 40% of metal surface is bare. 50% of metal surface is |
| | covered with a thin film. 10% of metal surface is covered |
| | with a thick film. |
| 15 minutes: | |
| Water Control | 40% of metal surface is covered with light film. 60% of |
| | metal surface is covered with a thick film. |
| Sample 1 | 100% of metal surface is bare. |
| Sample 2 | 80% of surface covered with a thin gelatinous film. |
| | 20% of metal surface is bare. |
| Sample 3 | 100% of surface covered with a thin gelatinous film |
| Alk Control | 80% of metal surface is bare. 10% of metal surface is |
| | covered with a thin film. 10% of metal surface is covered |
| | with a thick film. |

It can be seen that sample 1, which incorporates not only the tetrasodium EDTA solution, but both KOH and polyacrylic acid solution, showed the best results. Sample 2 incorporating the KOH solution without the polyacrylic acid solution was less effective, but more effective than sample 3, which incorporated the polyacrylic acid solution and excluded the KOH solution.

While the invention has been described in connection with what is presently considered to be the most practical and preferred embodiments, it is to be understood that the invention is not to be limited to the disclosed embodiments but, on the contrary, is intended to cover various modifications and equivalent arrangements included within the spirit and scope of the appended claims.

The above examples and disclosure are intended to be illustrative and not exhaustive. These examples and description will suggest many variations and alternatives to one of ordinary skill in this art. All these alternatives and variations are intended to be included within the scope of the claims, where the term “comprising” means “including, but not limited to”. Those familiar with the art may recognize other equivalents to the specific embodiments described herein which equivalents are also intended to be encompassed by the claims. Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below (e.g. claim 3 may be taken as alternatively dependent from claim 2; claim 5 may be taken as alternatively dependent on claim 2, claim 3 or claim 4; claim 12 may be taken as alternatively dependent from claim 11; etc.).

1. A method for removing gross soils from a substrate during a multi-step cleaning process comprising the step of flushing the substrate with a pre-rinse solution prior to application of said cleaning solution, said pre-rinse solution comprising water and a partially neutralized anionic polymer.

2. The method of claim 1 wherein said partially neutralized anionic polymer is selected from polyacrylates, polymethacrylates, polysulfonates, polyphosphates, polyphosphonates, phosphino polycarboxylates, polyaspartates, polycarboxylated alcohol alkoxylates, copolymers thereof, and mixtures thereof.

3. The method of claim 1 wherein said pre-rinse comprises from about 5 to about 5000 ppm of said partially neutralized anionic polymer.

4. The method of claim 1 wherein said pre-rinse further comprises a co-builder which is ethylenediaminetetraacetic acid, diethylenetraminepentaacetic acid, hydroxyethylethylenediaminetetraacetic acid, aminotri(methylenephosphonic acid), 2-phosphonobutane-1,2,4-tricarboxylic acid, diethylenetriaminepenta(methylenephophonic acid), and mixtures thereof.

5. The method of claim 1 wherein said partially neutralized anionic polymer is a polyacrylate comprising from about 10% to about 90% by weight of a substituted acrylic monomer or salt thereof having the general formula 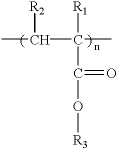
where R₁ or R₂ are independently hydrogen or a C₁ to C₄ alkyl or hydroxyalkyl, and R₃ is hydrogen or an alkali metal salt.

6. The method of claim 1 wherein said pH of said pre-rinse solution is about 4 to about 11.

7. The method of claim 1 wherein said pH of said pre-rinse solution is about 5 to about 10.

8. The method of claim 1 wherein said multi-step cleaning process is selected from laundry washing, dishwashing, warewashing, hard surface cleaning, clean-in-place and clean-out-of-place.

9. The method of claim 7 wherein said multi-step cleaning process is a clean-in-place cleaning of heat transfer equipment surfaces or a clean-out-of-place cleaning of heat transfer equipment surfaces.

10. The method of claim 1 further comprising the step of flushing the substrate with at least one other rinse solution.

11. The method of claim 10 wherein said rinse solution is acidic, caustic or neutral.

12. The method of claim 1 further comprising the step of cleaning said substrate with a main wash solution which is an enzymatic solution, a caustic solution, an acidic solution, a neutral solution, or mixture thereof.

13. The method of claim 1 wherein said substrate is metallic, polymeric or glass.

14. The method of claim 13 wherein said substrate is stainless steel, copper, brass, aluminum, plastic or glass.

15. The method of claim 1 wherein said substrate is a hard surface.

16. The method of claim 15 wherein said hard surface is a surface that comes into contact with food.

17. The method of claim 15 wherein said hard surface is a pipeline, tank, or silo.

18. The method of claim 1 wherein said substrate is a porous surface.

19. The method of claim 18 wherein said porous surface is a textile or membrane filter.

20. The method of claim 1 wherein said gross soil comprises whey, whey fractions, milk, milk fractions, or other milk product.

21. A multi-step method for cleaning hard surfaces comprising the steps of:
a) flushing with a pre-rinse solution said pre-rinse solution comprising water and a partially neutralized anionic polymer; and
b) further comprising at least one other step which is either flushing with at least one other rinse solution said rinse solution being either acidic, caustic or neutral, or cleaning with a main wash solution, or both.

22. The method of claim 21 wherein said partially neutralized anionic polymer is selected from polyacrylates, polymethacrylates, polysulfonates, polyphosphates, polyphosphonates, phosphino polycarboxylates, polyaspartates, polycarboxylated alcohol alkoxylates, copolymers thereof, and mixtures thereof;

23. The method of claim 21 wherein said main wash solution is an enzymatic wash solution, a caustic wash solution, an acidic wash solution or a neutral wash solution.

24. The method of claim 21 wherein said pre-rinse comprises from about 25 to about 10000 ppm of said partially neutralized anionic polymer.

25. The method of claim 21 wherein said pH of said pre-rinse solution is about 4 to about 11.

26. The method of claim 21 wherein said pre-rinse solution removes gross soils.

27. The method of claim 26 wherein said gross soil comprises whey, whey fractions, milk, milk fractions, or milk products.
